(19) United States
(12) Patent Application Publication
(10) Pub. No.: US 2011/0116608 A1
(43) Pub. Date: May 19, 2011

(54) METHOD OF PROVIDING TWO-WAY COMMUNICATION BETWEEN A DEAF PERSON AND A HEARING PERSON

(76) Inventor: Gwendolyn Simmons, Florissant, MO (US)

(21) Appl. No.: 12/621,097

(22) Filed: Nov. 18, 2009

(51) Int. Cl. H04M 11/00; G06F 17/20

(52) U.S. Cl. 379/52; 704/8

(57) ABSTRACT

A method of two-way communications between a deaf or hearing impaired person and a hearing person. Each person has a device (10) capable of communicating with each other. One of the devices executes a type-to-sign protocol for translating speech by the hearing person into corresponding signs displayed to the deaf or hearing impaired person. The other device executes a sign-to-speak protocol for translating language entered into the deaf or hearing impaired person's device into speech broadcast for the hearing person to hear from the hearing person's device. A display (18) for the deaf or hearing impaired person on that person's device displays imagery (20) of signs representing the speech of the hearing person.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates to instantaneous communications between a deaf person and a hearing person even when they are remote from each other; and, more particularly, to a method implemented using a computer program which establishes two-way communications between the hearing person and deaf person both in English as well in other languages and which translates between two languages.

In this digital age and age of communicating using a wide range of technologies, it is important to provide hearing and deaf persons the capability of readily communicating with each other, not only in person, but also when they are apart. Particularly where a hearing person and a deaf person are remote from each other, it is desirable that the deaf person have displayed for them on a device, without undue delay, signs representing the actual speech of the hearing person, as that person speaks. The hearing person can either speak or type words into his device. This speech is converted into an electronic, digital format and transmitted to the deaf person's device. The device then converts the received information into appropriate signs visually displayed on a monitor or screen for the deaf person to see.

Conversely, it is desirable that the hearing person be able to immediately hear speech which has been translated from typed text entered into a device used by the deaf person into words they can hear. In this regard, the deaf person types in his/her message and corresponding to the message typed “speech” is heard from the hearing person's device. The typed words are displayed on his monitor or screen as he enters the words he wishes to communicate. The signs are converted into an electronic, digital format which is transmitted to the hearing person's device. There, they are converted into audio sounds and broadcast for the hearing person to hear.

It will be understood that devices that enable a deaf person and a hearing person to communicate with other currently exist. However, these devices have drawbacks. One such device, for example, is essentially only a dictionary that links to videos of a person signing words and letters on the screen of a device. It basically teaches a person how to sign words and letters. While useful in this regard, it does not enable direct, real time conversations between a hearing impaired person and a hearing person.

### BRIEF SUMMARY OF THE INVENTION

The present invention is directed to a method of two-way communications between a hearing person and a deaf person. Each person utilizes a separate device. The device employed by the deaf person has a screen or monitor on which is displayed signs representing speech. The device employed by the hearing person has a microphone into which the person speaks, and a speaker over which human speech is broadcast. When the hearing person speaks, the contents of his speech are converted into appropriate signs displayed on the deaf person's monitor. The signs are those readily recognizable by the hearing impaired person. When the deaf person enters typed text representing his speech into his device, the contents of that speech are converted into words and broadcast for the hearing person to hear via his device.

It is a feature of the invention that the devices are portable devices usable with a variety of communication media including the plain old telephone system (POTS), the internet, RF wireless transmissions, Bluetooth, etc.

It is further a feature of the invention for the users to be able to select from one of a number of languages in which to communicate, as well as to translate from one selected language into another selected language.

Another feature of the invention is a method which is readily implemented in software and stored in the devices.

Other objects and features will be in part apparent and in part pointed out hereinafter.

### BRIEF DESCRIPTION OF THE SEVERAL VIEWS OF THE DRAWINGS

The foregoing and other objects, features, and advantages of the invention as well as the presently preferred embodiment thereof will become more apparent from the reading of the following description in connection with the accompanying drawing.

FIG. 1 illustrates a two-way conversation between a hearing person and a deaf person; and,

FIG. 2 is a flowchart illustrating method of two-way communications between a hearing person and a deaf person.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

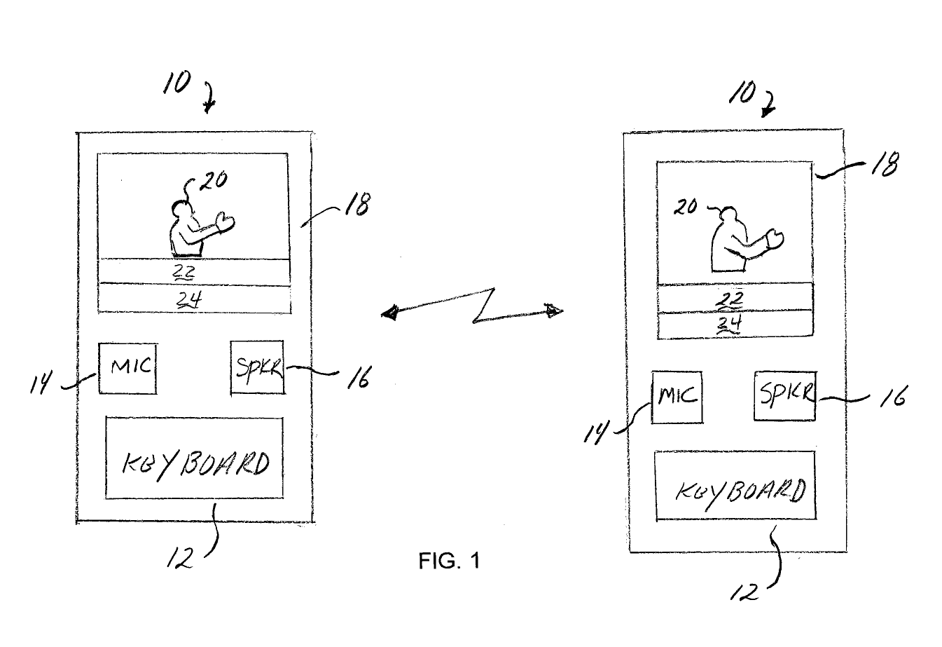

Referring to the drawings, the present invention is directed to a method by which a two-way communications path is established between a deaf person and a hearing person enabling them to “talk” to each other particularly when they are some distance apart. As shown in FIG. 1, in one embodiment of the invention, the hearing person and the deaf person each are equipped with a portable handheld device 10. Both devices shown in FIG. 1 are identical; although one device can be configured for exclusive use by a deaf person and the other device for exclusive use by a hearing person. Each device 10 shown in FIG. 1 includes a keyboard 12, a microphone (MIC) 14, a speaker (SPKR) 16, and a monitor 18. It will be understood by those skilled in the art that the hearing person can use a headset with a built in microphone and speaker and connected to the device for communicating with the deaf or hearing impaired person.

The devices 10 are capable of communicating with one another using a variety of technologies including: Internet, Wireless, Bluetooth, Infra Red or Direct connection. The devices also implement a speak-to-sign and type-to-speak protocol such as SignsLator™, and have a thumb drive memory and print features. As shown in FIG. 1, speech-to-sign appears in the center of screen 18 of the device. The feature can be either via half body as shown in FIG. 1, full body animated, a virtual person, or signing hands. As noted below, use of speech recognition software and related computer technologies enables spoken words to be converted to signs which are displayed through the animated half body, full body, virtual person, or signing hands feature implemented on the device. In return, the hearing person will hear aloud from the device what the deaf person is communicating, through typing and displaying on the screen, from the device's speaker 16.

In use, a hearing person speaks into the microphone 14 of his device 10. An electronics module (not shown) converts his speech into a digital electronic signal which is then transmitted from his device 10 to the device 10 being used by the deaf or hearing impaired person. When the transmitted signal is received by the other device 10, an electronics module (not shown) of the device processes the signal and performs the following functions:

a) it converts the signal back into speech which can be broadcast through the speaker 16 of the unit;

b) it determines which signs stored in a look-up table of the device correspond to the speech;

c) it sequentially displays the signs on the monitor corresponding to the sequence in which words or phrases are spoken; and,

d) it scrolls the words across the bottom of the monitor as the representative signs are displayed on the monitor.

With respect to the display, a FIG. 20 is displayed on the monitor and this figure “performs” the appropriate signing corresponding to the received speech. Monitor 18 further includes a scroll line 22 which extends across the bottom of the screen. As the FIG. 20 performs the signing, the corresponding words or phrases are scrolled across line 22.

When deaf person wishes to communicate, he types what he wishes to communicate into his device using its keyboard 12. The electronics module in his device converts what has been typed into a digital electronic signal which is then transmitted from his device 10 to the device 10 being used by hearing person. When the transmitted signal is received by the other device 10, the electronics module in his device processes the signal and performs the following functions:

a) it converts the signal into audio sounds, i.e., speech, which is then broadcast through speaker 16 of the hearing person's unit; and,

b) it scrolls the words across the bottom of the monitor simultaneously as the words are broadcast.

As with the other device 10, monitor 18 of the hearing person's device also includes a scroll line 22 which extends across the bottom of the screen. As the words are broadcast, the words are scrolled across line 22.

Those skilled in the art will recognize that device 20 can be implemented in a variety of ways without departing from the scope of the invention. The device can be implemented using a personal computer (PC), and IPOD, an MP3 player, and other types of personal digital assistant (PDA) devices.

It is feature of the invention that the method allows one of the people to communicate in one language understood by one of the speakers which is then translated into a separate language which is understood by the other speaker. In accordance with the method of the invention, the languages translated include, for example, and without limitation, English, Spanish, French, German, Chinese, and Japanese. Besides an audio translation of these languages, they are also visually translated into sign language for the deaf and hard of hearing. This facilitates, for example, face-to-face communication for everyday travel use.

Referring again to FIG. 1, in addition to the scroll line 22, each device 10 further includes a second scroll line 24. When one language is translated into another, the language used by the “speaker” is scrolled across one of the lines, while the translated language is scrolled across the other line. The signing performed by the FIG. 20 on monitor 18 is in the language of the deaf or hearing impaired person using the device; while the words broadcast from speaker 16 of the hearing person's device is that of the hearing person.

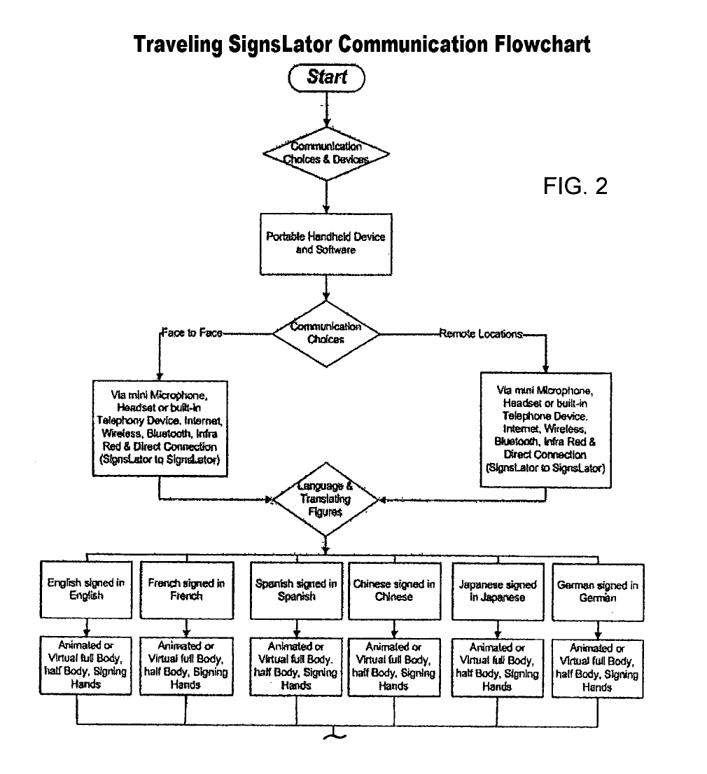

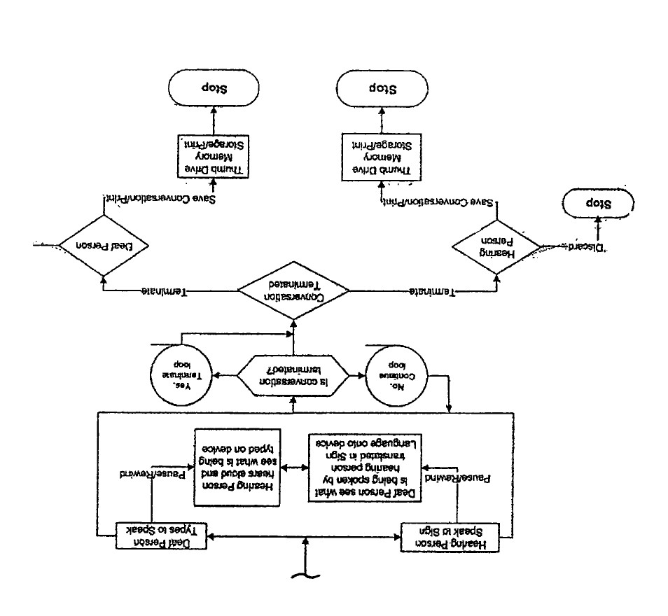

The flowchart of FIG. 2, illustrates the steps implemented in accordance with the method of the invention to incorporate the translation feature and other described features of the invention. As such, software by which the various processes shown in the flow chart are achieved is incorporated in the devices 10 used by hearing and hearing impaired or deaf persons.

Finally, those skilled in the art will appreciate that a significant advantage of the invention is that provides a real-time communications link from the hearing person to the deaf person in a wide range of different settings; breaking the barrier of communication with different generations, the youth, adult and the senior people. The invention can also be used to build-up the confidence of poor spellers and people who do not text or otherwise shy away from communicating with the deaf, because of lack of knowledge, education or computer technology skills.

1. A method of two-way communications between a deaf or hearing impaired person and a hearing person comprising:
providing each person with a device capable of communicating with each other, one of the devices performing a speak-to-sign protocol for translating speech by the hearing person into corresponding signs displayed to the deaf or hearing impaired person and the other device performing a type-to-speak protocol for translating language entered into the deaf or hearing impaired person's device into speech broadcast for the hearing person to hear from the hearing person's device; and,
displaying for the deaf or hearing impaired person on that person's device, imagery of signs representing the speech of the hearing person.

2. The method of claim 1 in which the devices include a personal computer (PC), and IPOD, an MP3 player, and a personal digital assistant (PDA) device.

3. The method of claim 2 in which communication between the devices includes telephone linkage, the Internet, Wireless, Bluetooth, and Infra Red or Direct connection.

4. The method of claim 1 which further allows one of the people to communicate in one language understood by one of the speakers which is then translated into a separate language which is understood by the other speaker.
